(19) United States
(12) Patent Application Publication
(10) Pub. No.: US 2023/0384500 A1
(43) Pub. Date: Nov. 30, 2023

(54) ULTRAVIOLET-STABLE OPTICAL FILMS

(71) Applicant: 3M INNOVATIVE PROPERTIES COMPANY, St. Paul, MN (US)

(72) Inventors: Matthew B. Johnson, Woodbury, MN (US); Adam D. Haag, Woodbury, MN (US)

(21) Appl. No.: 18/249,426

(22) PCT Filed: Oct. 13, 2021
(86) PCT No.: PCT/IB2021/059412

§ 371 Date: Apr. 18, 2023

Related U.S. Application Data
(60) Provisional application No. 63/094,692, filed on Oct. 21, 2020.

(51) Int. Cl. G02B 5/30; G02B 27/01

(52) U.S. Cl. CPC G02B 5/305; G02B 27/0101; G02B 5/3066

(57) ABSTRACT

An optical stack includes a first optical film with a plurality of first polymeric layers disposed on a second optical film with a plurality of second polymeric layers, such that for an incident light and for a first polarization state: a reflectance of the plurality of first polymeric layers versus wavelength has a reflection band edge separating a shorter wavelength range with higher reflectance a longer wavelength range with lower reflectance; for at least a first wavelength in the shorter wavelength range, the plurality of second polymeric layers reflects less than about 70% of the incident light, and for at least a second wavelength in the longer wavelength range, the plurality of second polymeric layers reflects greater than about 80% of the incident light; and in the shorter wavelength range, the pluralities of first and second polymeric layers absorbs respective A1% and A2% of the incident light, A2/A1≥50.

### SUMMARY

In some aspects of the present description, an optical stack is provided, the optical stack including a first optical film with a plurality of first polymeric layers disposed on a second optical film with a plurality of second polymeric layers. Each of the pluralities of first and second polymeric layers numbers at least 50 in total, and each of the first and second polymeric layers have an average thickness of less than about 500 nm. For light incident at an incident angle and for a first polarization state, an optical reflectance of the plurality of first polymeric layers versus wavelength has a reflection band edge separating a shorter wavelength range, where the plurality of first polymeric layers reflects greater than about 70% of the incident light, from a longer wavelength range, where the plurality of first polymeric layers reflects less than about 30% of the incident light. For at least a first wavelength in the shorter wavelength range, the plurality of second polymeric layers reflects less than about 70% of the incident light, and for at least a second wavelength in the longer wavelength range, the plurality of second polymeric layers reflects greater than about 80% of the incident light. In the shorter wavelength range, the pluralities of first and second polymeric layers absorb respective A1% and A2% of the incident light, such that A2/A1 is greater than or equal to about 50, or about 75, or about 100, or about 150.

In some aspects of the present description, an optical stack is provided, the optical stack including a first optical film with a plurality of first polymeric layers disposed on a second optical film with a plurality of second polymeric layers. Each of the pluralities of first and second polymeric layers numbers at least 50 in total, and each of the first and second polymeric layers has an average thickness of less than about 500 nm. For a light incident at an incident angle and for a first polarization state: an optical reflectance of the plurality of first polymeric layers versus wavelength has a reflection band edge extending at least between a higher first optical reflectance at a smaller first wavelength and a lower second optical reflectance at a greater second wavelength. An optical reflectance of the plurality second polymeric layers over a band edge wavelength range extending from the smaller first wavelength to the greater second wavelength has an average value of greater than about 80% and varies by less than about 20%. In the band edge wavelength range, the pluralities of first and second polymeric layers absorb respective A1′% and A2′% of the incident light, such that A2′/A1′ is greater than or equal to about 2, or about 3, or about 4, or about 5 or about 6.

In some aspects of the present description, a display system is provided, the display system including an extended light source, a mirror, and a reflective polarizer. The extended light source is configured to emit light from an emission surface thereof, the emitted light having a blue emission peak at a blue peak wavelength and a corresponding full width at half maximum extending from a smaller first blue wavelength to a greater second blue wavelength. The reflective polarizer is configured to receive the light emitted by the extended light source through the mirror. Each of the mirror and the reflective polarizer include a plurality of polymeric layers numbering at least 50 in total. For a light incident at an incident angle: for the wavelengths between the first and the second blue wavelengths, the reflective polarizer has an average reflectance of greater than about 60% for a first polarization state and an average transmittance of greater than about 60% for an orthogonal second polarization state, and an optical reflectance of the mirror versus wavelength for each of the first and second polarization states includes a reflection band edge extending at least between a higher first optical reflectance R1 at a smaller first wavelength L1 and a lower second optical reflectance R2 at a greater second wavelength L2, such that R1−R2 is greater than or equal to about 40%, or about 45%, or about 50%, or about 55%, or about 60%, L2−L1 is less than or equal to about nm, or about 40 nm, or about 30 nm, or about 25 nm, or about 20 nm, or about 15 nm. For at least one wavelength smaller than, and within, about 50 nm of L1, the mirror and the reflective polarizer absorb respective A1″% and A2″% of the incident light, such that the ratio A2″/A1″ is greater than or equal to about 2, or about 5, or about 10.

In some aspects of the present description, a display system is provided, the display system including an extended light source configured to emit light and a mirror. The extended light source has a blue emission peak at a blue peak wavelength having an emission intensity Ib and a corresponding full width at half maximum extending from a smaller first blue wavelength to a greater second blue wavelength, and an ultraviolet (UV) emission at a UV wavelength less than the first blue wavelength and having an emission intensity Iuv, such that Iuv/Ib is greater than about 10⁻⁴, or about 2×10⁻⁴, or about 5×10⁻⁴, or about 7.5×10⁻⁴, or about 10⁻³, and Iuv/Ib is less than about 10⁻¹, or about 10⁻², or about 8×10⁻³, or about 6×10⁻³, or about 4×10⁻³. The mirror is configured to receive the light emitted by the extended light source and includes a plurality of first polymeric layers numbering at least 50 in total, each of the first polymeric layers having an average thickness of less than about 500 nm, such that for a light incident at an incident angle and for each of mutually orthogonal first and second polarization states, the plurality of first polymeric layers reflects at least about 60%, or about 70%, or about 80%, or about 90%, or about 95% of the incident light at the UV wavelength and transmits at least about 60%, or about 70%, or about 80%, or about 85%, of the incident light at the blue peak wavelength.

In some aspects of the present description, a display system is provided, the display system including an extended light source and a mirror. The extended light source is configured to emit light having a blue emission peak at a blue peak wavelength having an emission intensity Ib and a corresponding full width at half maximum extending from a smaller first blue wavelength to a greater second blue wavelength. The mirror is configured to receive the light emitted by the extended light source and has a plurality of first polymeric layers numbering at least 50 in total. Each of the first polymeric layers has an average thickness of less than about 500 nm. For a light incident at an incident angle and for each of mutually orthogonal first and second polarization states, an optical reflectance of the plurality of first polymeric layers versus wavelength has a reflection band edge separating a shorter wavelength range where the plurality of first polymeric layers reflects greater than about 70% of the incident light from a longer wavelength range where the plurality of first polymeric layers reflects less than about 30% of the incident light. Along the reflection band edge, the optical reflectance of the of the plurality of first polymeric layers decreases from about 80% at a shorter first band edge wavelength to about 30% at a longer second band edge wavelength, the first and second band edge wavelengths less than, and disposed within less than about 50 nm of, the first blue wavelength. A best linear fit to the reflection band edge at least across the wavelength range from the first band edge wavelength to the second band edge wavelength has a negative slope having a magnitude of greater than about 3%/nm, or about 3.5%/nm, or about 4.5%/nm, or about 5%/nm.

### BRIEF DESCRIPTION OF THE DRAWINGS

FIG. 1 is a side view of a display system including UV stable optical films, in accordance with an embodiment of the present description;

FIGS. 2A-2C provide side views of a heads-up display system for presenting an image to a viewer, in accordance with an embodiment of the present description;

FIGS. 3A-3B provide side views showing additional detail on multi-layer optical films, in accordance with an embodiment of the present description;

FIG. 4 is a graph showing percent reflectance versus wavelength for embodiments of UV stable optical films, in accordance with an embodiment of the present description;

FIG. 5 is a graph showing percent reflectance versus wavelength for additional embodiments of UV stable optical films, in accordance with an embodiment of the present description;

FIG. 6 is a graph showing percent reflectance versus wavelength for additional embodiments of UV stable optical films, in accordance with an embodiment of the present description;

FIG. 7 is a graph showing percent reflectance versus wavelength for additional embodiments of UV stable optical films, in accordance with an embodiment of the present description;

FIG. 8 is a graph showing percent reflectance versus wavelength for additional embodiments of UV stable optical films, in accordance with an embodiment of the present description; and

FIG. 9 is a graph showing percent reflectance versus wavelength for additional embodiments of UV stable optical films, in accordance with an embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Cold mirrors are sometimes used in heads up display (HUD) systems to allow for damaging incoming solar radiation to pass into a heat sink. In the last few years, broadband polarizing cold mirror films (CMF) have been developed to allow for additional solar heat to pass through the CMF into a heat sink. Traditionally, multilayer optical films (MOF) containing polymers such as PEN are well known to “yellow” in high ultraviolet (UV) environments such as sunlight. This often means that PEN or any polymer containing naphthalene dicarboxylic acid (NDC) are not useable applications having exposure to sunlight (such as windshields, heads-up displays, etc.).

According to some aspects of the present description, optical stacks including UV blocking mirrors in combination with high contrast ratio reflective polarizers may be used to create polarizing cold mirrors for heads-up displays and other automotive or outdoor applications. In some embodiments, the UV blocking mirrors may be used to protect high contrast ratio reflective polarizers from blue light sources (such as LEDs) in a backlight, which may contain damaging UV wavelengths. An optical stack may include a first optical film (e.g., a mirror) with a plurality of first polymeric layers disposed on a second optical film (e.g., a reflective polarizer) with a plurality of second polymeric layers. Each of the pluralities of first and second polymeric layers may number at least 50 in total, and each of the first and second polymeric layers may have an average thickness of less than about 500 nm. In some embodiments, the plurality of first polymeric layers may number at least 75, or at least 100, or at least 150, or at least 200, or at least 250, in total. In some embodiments, the plurality of second polymeric layers may number at least 100, or at least 200, or at least 300, or at least 400, or at least 500, or at least 600, in total.

For light incident at an incident angle and for a first polarization state (e.g., light polarized to a first, or x-axis, of a film), an optical reflectance of the plurality of first polymeric layers versus wavelength may have a reflection band edge separating a shorter wavelength range (e.g., a range including ultraviolet wavelengths), where the plurality of first polymeric layers reflects greater than about 70% of the incident light, from a longer wavelength range (e.g., a range including human-visible and infrared wavelengths), where the plurality of first polymeric layers reflects less than about 30% of the incident light. For at least a first wavelength in the shorter wavelength range, the plurality of second polymeric layers may reflect less than about 70% of the incident light, and for at least a second wavelength in the longer wavelength range, the plurality of second polymeric layers may reflect greater than about 80% of the incident light. In the shorter wavelength range, the pluralities of first and second polymeric layers may absorb respective A1% and A2% of the incident light, such that the ratio of A2/A1 is greater than or equal to about 50, or about 75, or about 100, or about 150.

In some embodiments, the incident angle (i.e., the angle at which the incident light impinges on the optical stack, as measured from a line orthogonal to a top plane of the stack) may be less than about 5 degrees, or less than about 4 degrees, or less than about 3 degrees, or less than about 2 degrees, or less than about 1 degree. In other embodiments, the incident angle may be between about 30 and about 60 degrees, or between about 35 and about 55 degrees, or between about 40 and about 50 degrees. Stated another way, the optical stack may be configured such that it provides the desired optical properties for light that is incident from an angle other than substantially normal to the top plane of the optical stack.

In some embodiments, the optical reflectance of the plurality of first polymeric layers along the reflection band edge may decrease from about 70% at a shorter first wavelength band to about 30% at a longer second band edge wavelength. For example, the first and second band edge wavelengths may be disposed between about 410 nm and about 440 nm. In some embodiments, a best linear fit to the reflection band edge, at least across a wavelength range along the reflection band edge where the optical transmittance decreases from about 80% to about 50%, may have a negative slope having a magnitude of greater than about 3%/nm, or about 3.5%/nm, or about 4.5%/nm, or about 5%/nm. In some embodiments, the best linear fit may have an R-squared value greater than about 0.8, or about 0.85, or about 0.9, or about 0.95.

In some embodiments, the first optical film may define an x-axis along a first polarization state, a y-axis along an orthogonal second polarization state perpendicular to the x-axis, and a z-axis along a thickness direction of the first optical film orthogonal to both the x-axis and the y-axis. In some embodiments, the plurality of first polymeric layers may include a plurality of alternating polymeric A (e.g., high index optics) and B (e.g., low index optics) layers. In some embodiments, each of the A and B layers may have an index, nx, along the x-axis, an index, ny, along the y-axis, and an index, nz, along the z-axis. In some embodiments, for each of the A layers, nx is greater than ny, ny is greater than nz. In some embodiments, nx is greater than ny by at least about 0.01, or at least about 0.015, or at least about 0.02, and ny is greater than nz by at least about 0.025, or at least about 0.05, or at least about 0.075, or at least about 0.1, or at least about 0.125. In some embodiments, for each of the B layers, a magnitude of a maximum difference between nx, ny and nz is less than about 0.01 (i.e., the index values are substantially the same). In some embodiments, a magnitude of a difference between the nz of the A and B layers is less than about 0.01 (i.e., the index values are substantially the same). In some embodiments, the plurality of first polymeric layers of the first optical film may include a plurality of alternating polymeric A and B layers, wherein each A layer may include polyethylene terephthalate (PET) and each B layer may include polymethylmethacrylate (PMMA).

In some embodiments, the second optical film (e.g., a reflective polarizer) may define an x-axis along a first polarization state, a y-axis along an orthogonal second polarization state perpendicular to the x-axis, and a z-axis along a thickness direction of the second optical film orthogonal to the x- and y-axes. In some embodiments, the plurality of second polymeric layers may include a plurality of alternating polymeric C (e.g., high index optics) and D (e.g., low index optics) layers. In some embodiments, each of the C and D layers has an index, nx, along the x-axis, an index, ny, along the y-axis, and an index, nz, along the z-axis. For each of the C layers, nx may be greater than ny, and ny may be greater than nz. In some embodiments, nx is greater than ny by at least about 0.05, or at least about 0.1, or at least about 0.15, or at least about 0.2, or at least about and ny is greater than nz by more than about 0.01 and less than about 0.03. In some embodiments, for each of the D layers, a magnitude of a maximum difference between nx, ny and nz is less than about 0.01 (i.e., the index values are substantially the same). In some embodiments, a magnitude of a difference between the nx of the A and B layers is greater than about 0.05, or greater than about 0.1, or greater than about 0.15, or greater than about 0.2, or greater than about In some embodiments, the plurality of second polymeric layers of the second optical film may include a plurality of alternating polymeric C and D layers, wherein each C layer may include polyethylene naphthalate (PEN) and each D layer may include polycarbonate (PC).

According to some aspects of the present description, an optical stack includes a first optical film (e.g., a mirror) with a plurality of first polymeric layers disposed on a second optical film (e.g., a reflective polarizer) with a plurality of second polymeric layers. Each of the pluralities of first and second polymeric layers numbers at least 50 in total, and each of the first and second polymeric layers has an average thickness of less than about 500 nm. In some embodiments, the plurality of first polymeric layers may number at least 75, or at least 100, or at least 150, or at least 200, or at least 250, in total. In some embodiments, the plurality of second polymeric layers may number at least 100, or at least 200, or at least 300, or at least 400, or at least 500, or at least 600, in total.

In some embodiments, for light incident at an incident angle and for a first polarization state (e.g., a polarization of light aligned with an x-axis of the of the optical stack), an optical reflectance of the plurality of first polymeric layers versus wavelength may have a reflection band edge extending at least between a higher first optical reflectance at a smaller first wavelength and a lower second optical reflectance at a greater second wavelength. In some embodiments, an optical reflectance of the plurality of second polymeric layers over a band edge wavelength range extending from the smaller first wavelength to the greater second wavelength has an average value of greater than about 80% and varies by less than about 20%.

In some embodiments, in the band edge wavelength range, the pluralities of first and second polymeric layers absorb respective A1′% and A2′% of the incident light, such that the ratio of A2′/A1′ is greater than or equal to about 2, or about 3, or about 4, or about 5 or about 6.

In some embodiments, the incident angle may be less than about 5 degrees, or less than about 4 degrees, or less than about 3 degrees, or less than about 2 degrees, or less than about 1 degree. In other embodiments, the incident angle may be between about 30 and about 60 degrees, or between about 35 and about 55 degrees, or between about 40 and about 50 degrees.

According to some aspects of the present description, a display system includes an extended light source (e.g., a backlight) having an emission surface, a mirror, and a reflective polarizer. In some embodiments, the emission surface, the mirror, and the reflective polarizer may be substantially parallel, and co-extensive in length and width, with each other. In other embodiments, the mirror and the reflective polarizer may be substantially parallel, and co-extensive in length and width, with each other, and the emission surface may make an angle of between about 20 degrees and 70 degrees with the mirror.

In some embodiments, the extended light source may be configured to emit light from the emission surface, wherein the emitted light has a blue emission peak at a blue peak wavelength and a corresponding full width at half maximum (FWHM) extending from a smaller first blue wavelength to a greater second blue wavelength.

In some embodiments, the reflective polarizer may be configured to receive the light emitted by the extended light source through the mirror. In some embodiments, each of the mirror and the reflective polarizer may include a plurality of polymeric layers numbering at least 50 in total. In some embodiments, for a light incident at an incident angle, and for the wavelengths between the first and the second blue wavelengths, the reflective polarizer may have an average reflectance of greater than about 60% for a first polarization state (e.g., a polarization of light aligned with an x-axis of the of the reflective polarizer) and an average transmittance of greater than about 60% for an orthogonal second polarization state (e.g., a polarization of light aligned with a y-axis of the of the reflective polarizer). In some embodiments, an optical reflectance of the mirror versus wavelength for each of the first and second polarization states may include a reflection band edge extending at least between a higher first optical reflectance R1 at a smaller first wavelength L1 and a lower second optical reflectance R2 at a greater second wavelength L2. In some embodiments, R1−R2 may be greater than or equal to about 40%, or about 45%, or about 50%, or about 55%, or about 60%, and L2−L1 is less than or equal to about 50 nm, or about 40 nm, or about 30 nm, or about 25 nm, or about 20 nm, or about 15 nm. In some embodiments, for at least one wavelength smaller than, and within, about 50 nm of L1, the mirror and the reflective polarizer may absorb respective A1″% and A2″% of the incident light, such that the ratio A2″/A1″ is greater than or equal to about 2, or about 5, or about 10.

In some embodiments, the incident angle may be less than about 5 degrees, or less than about 4 degrees, or less than about 3 degrees, or less than about 2 degrees, or less than about 1 degree. In other embodiments, the incident angle may be between about 30 and about 60 degrees, or between about 35 and about 55 degrees, or between about 40 and about 50 degrees.

In some embodiments, the extended light source may include an image forming display panel having a plurality of pixels, and the emitted light may include an emitted image light. In some embodiments, the display system may be a virtual reality display system for forming a virtual image of an image emitted by the image forming display panel for viewing by a viewer. In some embodiments, the display system may also include first and second at least partial mirrors, such that the image emitted by the image forming display panel propagates toward the viewer after it is first received and reflected by the reflective polarizer toward the first at least partial mirror, and then reflected by the first at least partial mirror toward the second at least partial mirror. In some embodiments, the second at least partial mirror may be the windshield of a vehicle.

According to some aspects of the present description, a display system includes an extended light source configured to emit light and a mirror. In some embodiments, the extended light source may have a blue emission peak at a blue peak wavelength having an emission intensity Ib, and a corresponding full width at half maximum (FHWM) extending from a smaller first blue wavelength to a greater second blue wavelength, and an ultraviolet (UV) emission at a UV wavelength less than the first blue wavelength and having an emission intensity Iuv, such that Iuv/Ib is greater than about 10⁻⁴, or about 2×10⁻⁴, or about 5×10⁻⁴, or about 7.5×10⁻⁴, or about 10⁻³, and Iuv/Ib is less than about 10⁻¹, or about 10⁻², or about 8×10⁻³, or about 6×10⁻³, or about 4×10⁻³.

In some embodiments, the mirror may be configured to receive the light emitted by the extended light source and may include a plurality of first polymeric layers numbering at least 50 in total, each of the first polymeric layers having an average thickness of less than about 500 nm. In some embodiments, and for a light incident at an incident angle and for each of mutually orthogonal first and second polarization states, the plurality of first polymeric layers may reflect at least about 60%, or about 70%, or about 80%, or about 90%, or about 95% of the incident light at the UV wavelength and may transmit at least about 60%, or about 70%, or about 80%, or about 85%, of the incident light at the blue peak wavelength.

In some embodiments, the incident angle may be less than about 5 degrees, or less than about 4 degrees, or less than about 3 degrees, or less than about 2 degrees, or less than about 1 degree. In other embodiments, the incident angle may be between about 30 and about 60 degrees, or between about 35 and about 55 degrees, or between about 40 and about 50 degrees.

According to some aspects of the present description, a display system includes an extended light source and a mirror. In some embodiments, the extended light source may be configured to emit light having a blue emission peak at a blue peak wavelength having an emission intensity Ib and a corresponding full width at half maximum (FWHM) extending from a smaller first blue wavelength to a greater second blue wavelength.

In some embodiments, the mirror may be configured to receive the light emitted by the extended light source and may have a plurality of first polymeric layers numbering at least 50 in total. In some embodiments, each of the first polymeric layers may have an average thickness of less than about 500 nm.

In some embodiments, for a light incident at an incident angle and for each of mutually orthogonal first and second polarization states, an optical reflectance of the plurality of first polymeric layers versus wavelength may have a reflection band edge separating a shorter wavelength range where the plurality of first polymeric layers reflects greater than about 70% of the incident light from a longer wavelength range where the plurality of first polymeric layers reflects less than about 30% of the incident light. In some embodiments, along the reflection band edge, the optical reflectance of the of the plurality of first polymeric layers may decrease from about 80% at a shorter first band edge wavelength to about 30% at a longer second band edge wavelength, wherein the first and second band edge wavelengths are less than, and disposed within less than about 50 nm of, the first blue wavelength.

In some embodiments, a best linear fit to the reflection band edge, at least across the wavelength range from the first band edge wavelength to the second band edge wavelength, may have a negative slope having a magnitude of greater than about 3%/nm, or about 3.5%/nm, or about 4.5%/nm, or about 5%/nm.

In some embodiments, the incident angle may be less than about 5 degrees, or less than about 4 degrees, or less than about 3 degrees, or less than about 2 degrees, or less than about 1 degree. In other embodiments, the incident angle may be between about 30 and about 60 degrees, or between about 35 and about 55 degrees, or between about 40 and about 50 degrees.

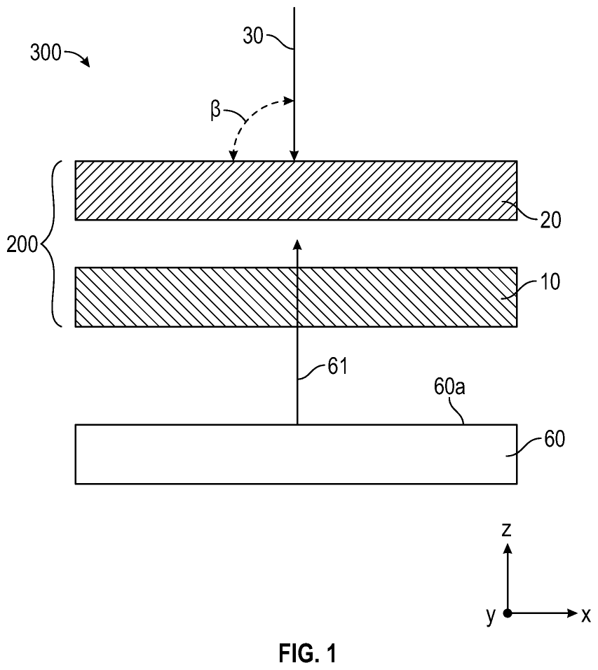

Turning now to the drawings, FIG. 1 shows a side view of a display system including UV stable optical films, according to the present description. In the embodiment shown, the display system 300 includes an extended light source 60 and an optical stack 200, which includes a mirror and a reflective polarizer 20. The extended light source 60 (e.g., an array of light-emitting diodes) may be configured to emit light 61 from an emission surface 60a. In some embodiments, light 61 may contain ultraviolent (UV) emission spectra (e.g., emitted blue light wavelengths are near and may contain some UV wavelengths) which can damage optical films (e.g., reflective polarizer 20). In some embodiments, mirror 10 may be configured to block or reflect at least a portion of the UV wavelengths. In some embodiments, the extended light source 60, the mirror 10, and the reflective polarizer 20 may be substantially parallel, and co-extensive with, each other, as shown in the configuration of FIG. 1.

Display system 300 may receive incident light 30 at an incident angle β. For incident light 30 and for a first polarization state (e.g., light polarized to the x-axis, as shown in FIG. 1), an optical reflectance of the mirror 10 versus wavelength may include a reflection band edge separating a shorter wavelength range (e.g., wavelengths including ultraviolet light) where the mirror 10 reflects greater than about 70%, or about 80%, or about 90%, or about 95%, of the incident light, from a longer wavelength range (e.g., including human-visible wavelengths) where the mirror 10 reflects less than about 30%, or about 25%, or about 20%, or about 15%, of the incident light.

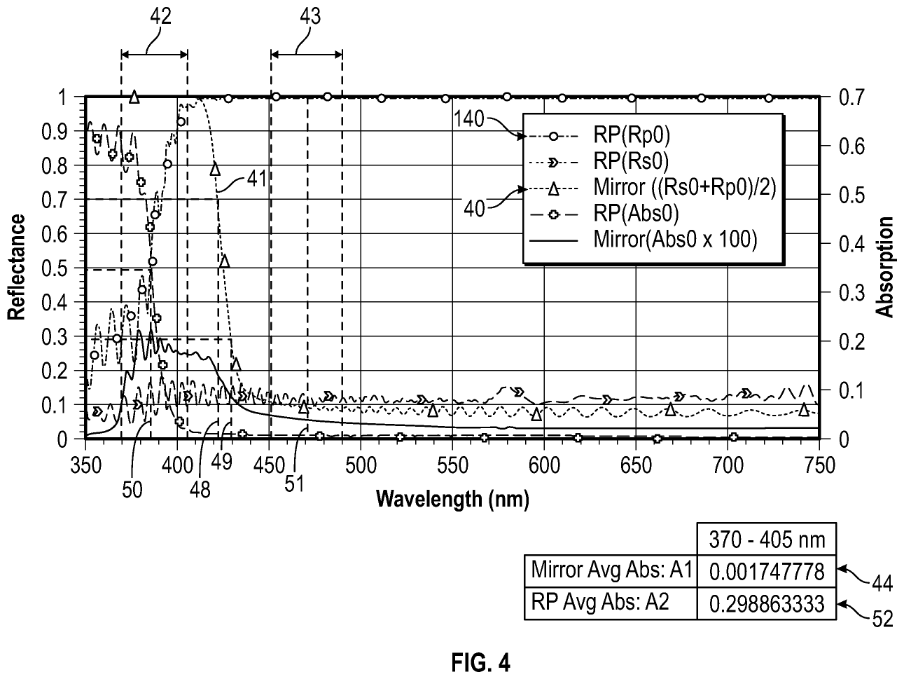

In some embodiments, for at least a first wavelength in the shorter wavelength range (e.g., a UV wavelength), the reflective polarizer 20 reflects less than about 70%, or less than about 60%, or less than about 50%, of the incident light, and for at least a second wavelength in the longer wavelength range (e.g., a human-visible wavelength), the reflective polarizer 20 reflects greater than about 80% of the incident light. In some embodiments, in the shorter wavelength range, the mirror 10 and the reflective polarizer 20 absorb respective A1% and A2% of the incident light, such that the ratio A2/A1 is greater than or equal to about 50, or about 75, or about 100, or about 150. Additional detail regarding the reflectance curves of mirror 10 and reflective polarizer 20 are provided in FIGS. 4-9.

In some embodiments, the incident angle β may be substantially normal to the surface of the display (that is, it may be less than about 5 degrees, or about 4 degrees, or about 3 degrees, or about 2 degrees, or about 1 degrees from the vertical, or the z-axis as shown in FIG. 1). In other embodiments, the incident angle β may be between about 30 degrees and about 60 degrees, or between about 35 degrees and about 55 degrees, or between about 40 degrees and about 50 degrees.

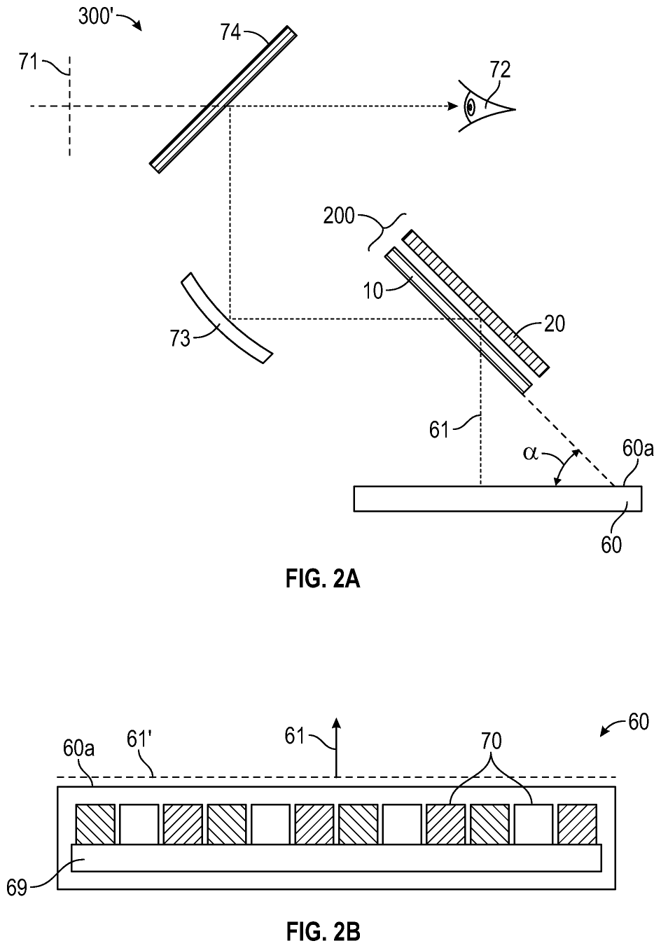

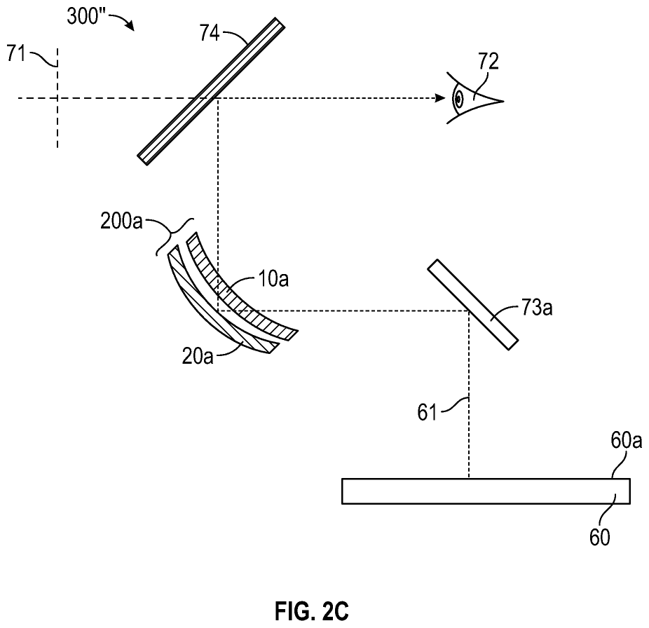

FIG. 2A shows an alternate embodiment from the display system of FIG. 1. In display system 300′, in the optical stack 200, the mirror 10 and the reflective polarizer 20 are substantially parallel, and co-extensive in length and width, with each other, and the extended emission surface 60 may make an angle α of between about 20 degrees and about 70 degrees with the optical stack 200 (e.g., with a surface of mirror 10). This arrangement may, for example, be used in a display system 300′ such as a heads-up display. In this arrangement, the extended light source 60 may include and image forming panel 69 (see FIG. 2B) which includes a number of pixels 70. The pixels 70 may be configured to emit an emitted light 61 which includes an emitted image 61′.

Display system 300′ may include a first at least partial mirror 73 and a second at least partial mirror 74, such that the image 61′ (see FIG. 2B), included in emitted light 61, propagates toward a viewer 72 after it is first received and reflected by reflective polarizer 20 toward first at least partial mirror 73, where it is reflected by first at least partial mirror 73 toward second at least partial mirror 74. In some embodiments, the second at least partial mirror 74 may be the windshield of a vehicle (e.g., such as in a heads-up display in the vehicle). In some embodiments, the first at least partial mirror 73 may be a second mirror, a second reflective polarizer, or another optical stack 200 (e.g., a curved version of optical stack 200). The emitted light 61 (including emitted image 61′) is reflected toward viewer 72, forming a virtual image 71 which appears to viewer 72 to be on an opposite side of second at least partial mirror 74 from viewer 72 (e.g., a virtual image appearing superimposed on a street in front of the vehicle). As already discussed herein, FIG. 2B provides additional details of extended light source 60.

It should be noted that the embodiment of the display system 300′ shown in FIG. 2A is an example embodiment only, and other embodiments are possible and within the scope of the disclosure. One such alternate embodiment is display system 300″ shown in FIG. 2C. FIG. 2C shares many components in common with the system of FIG. 2A, and like-numbered components should be assumed to serve a similar function to those in FIG. 2A unless otherwise specified. In display system 300″, the locations of optical stack 200a (which includes mirror 10a and reflective polarizer 20a) and first at least partial mirror 73a are reversed from their similarly-numbered components (optical stack 200 and first at least partial mirror 73) in FIG. 2A. Optical stack 200a is substantially similar in function to optical stack 200 of FIG. 2A, but may be curved or otherwise shaped, depending on the optical requirements of the system. Also, first at least partial mirror 73a is substantially similar in function to first at least partial mirror 73 of FIG. 2A, but may be differently shaped or configured (e.g., may be substantially flat), depending on the optical requirements. In other embodiments of the display system, an optical stack (such as optical stack 200 or 200a) may be used in both positions of the light path (that is, first at least partial mirror 73a may itself be an optical stack, such as 200 or 200a). In some embodiments, first at least partial mirror 73a may also be a second mirror or a second reflective polarizer.

Other embodiments of display systems beyond those explicitly presented in the figures and text herein may use an optical stack such as optical stack 200 of FIG. 2A or optical stack 200a of FIG. 2C. For example, an optical stack as described herein may be used in a display system such as that described in International Patent Publication WO 2020/128841, the entirety of which is hereby incorporated by reference.

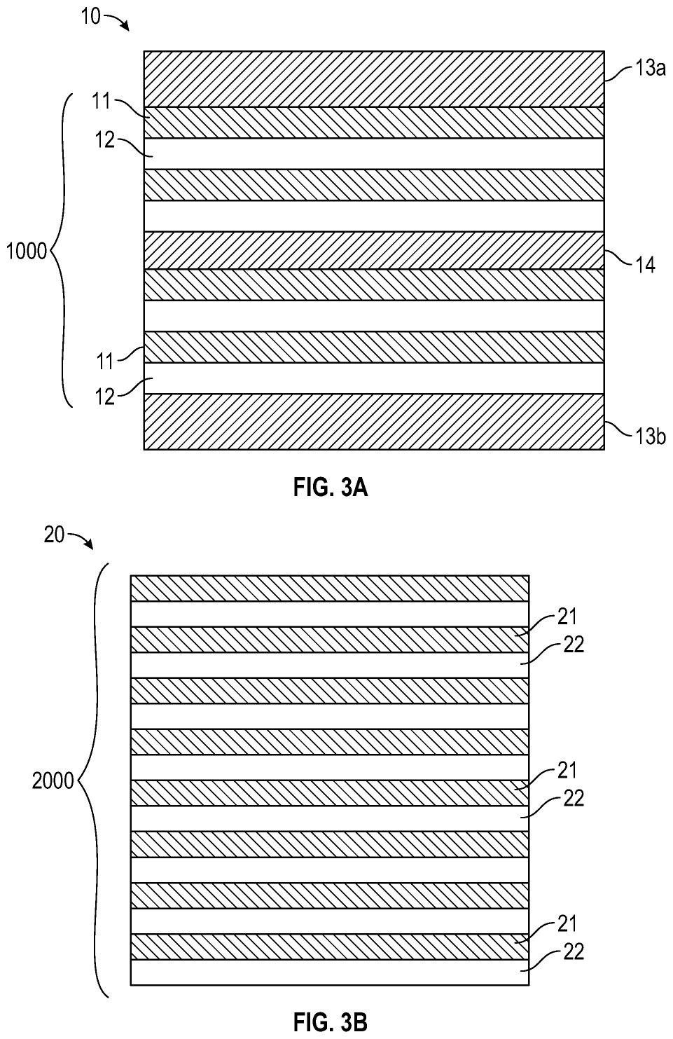

FIGS. 3A-3B provide side views showing additional detail on the mirror 10 and reflective polarizer 20 respectively. FIG. 3A shows mirror 10 (i.e., first optical film 10 from optical stack 200 of FIGS. 1 and 2), which may include a plurality of first polymeric layers 1000 including alternating polymeric layers 11 and 12. In some embodiments, the first polymeric layers 1000 may number at least 75, or at least 100, or at least 150, or at least 200, or at least 250, in total. In some embodiments, mirror 10 may further include a first outermost polymeric layer 13a, a second outermost polymeric layer 13b, and a middle polymeric layer 14 dividing a first section of first polymeric layers 1000 from a second section of first polymeric layers 1000.

Alternating polymeric layers 11 and 12 may form an alternating A-B-A-B pattern, where layers 11 are A layers and include polyethylene terephthalate (PET), and layers 12 are B layers and include polymethylmethacrylate (PMMA). In some embodiments, the mirror 10 may define an x-axis along a first polarization state, a y-axis along an orthogonal second polarization state perpendicular to the x-axis, and a z-axis along a thickness direction of the first optical film orthogonal to the x- and y-axes. Each of the A (11) and B (12) layers may have an index, nx, along the x-axis, an index, ny, along the y-axis, and an index, nz along the z-axis, such that for the A (11) layers, nx is greater than, ny is greater than nz, and nx is greater than ny by at least about 0.01, or about 0.015, or about 0.02, and ny is greater than nz by at least about 0.025, or about 0.05, or about or about 0.1, or about 0.125, and such that for the B (12) layers, a magnitude of a maximum difference between nx, ny and nz is less than about 0.01, and such that a magnitude of a difference between the nz of the A and B layers is less than about 0.01. In some embodiments, each of the first polymeric layers 1000 may have an average thickness of less than about 500 nm.

FIG. 3B shows reflective polarizer 20 (i.e., second optical film 20 from optical stack 200 of FIGS. 1 and 2), which may include a plurality of second polymeric layers 2000 including alternating polymeric layers 21 and 22. In some embodiments, the second polymeric layers 2000 may number at least 100, or at least 200, or at least 300, or at least 400, or at least 500, or at least 600, in total. Alternating polymeric layers 21 and 22 may form an alternating C-D-C-D pattern, where layers 21 are C layers and include polyethylene naphthalate (PEN), and layers 22 are D layers and include polycarbonate (PC). In some embodiments, the reflective polarizer 20 may define an x-axis along a first polarization state, a y-axis along an orthogonal second polarization state perpendicular to the x-axis, and a z-axis along a thickness direction of the first optical film orthogonal to the x- and y-axes.

Each of the C (21) and D (22) layers may have an index, nx, along the x-axis, an index, ny, along the y-axis, and an index, nz along the z-axis, such that for the C (21) layers, nx is greater than, ny is greater than nz, and nx is greater than ny by at least about 0.01, or about 0.015, or about and ny is greater than nz by at least about 0.01 and less than about 0.3, and such that for the D (22) layers, a magnitude of a maximum difference between nx, ny and nz is less than about 0.01, and such that a magnitude of a difference between the nx of the C and D layers is less than about or about 0.1, or about 0.15, or about 0.2, or about 0./22. In some embodiments, each of the second polymeric layers 2000 may have an average thickness of less than about 500 nm.

FIGS. 4 through 9 are graphs plotting percent reflectance versus wavelength for several embodiments of UV stable optical films, according to the present description. FIG. 4 shows the optical reflectance 40 (the line including triangles) of a mirror (such as mirror 10 of FIGS. 1 and 2) versus wavelength. In some embodiments, the optical reflectance 40 may have a reflection band edge 41 which separates a shorter wavelength range 42 from a longer wavelength range 43. In shorter wavelength range 42, the mirror 10 reflects greater than about 70%, or greater than about 80%, or greater than about 90%, of incident light (such as incident light 30, FIG. 1). In longer wavelength range 43, the mirror 10 reflects less than about 30%, or less than about 25%, or less than about 20%, or less than about 15%, of the incident light. Along reflection band edge 41, the optical reflectance 40 of mirror 10 decreases from about 70% at a shorter first band edge wavelength 48 to about 30% at a longer second band edge wavelength 49. In some embodiments, the first band edge wavelength 48 and the second band edge wavelength 49 are disposed between about 410 nm and about 440 nm.

FIG. 4 also shows the optical reflectance 140 (the line including circles) of a reflective polarizer (such as reflective polarizer 20 of FIGS. 1 and 2) versus wavelength. In some embodiments, for at least a first wavelength 50 in the shorter wavelength range 42, the reflective polarizer 20 reflects less than about 70%, or less than about 60%, or less than about 50%, of the incident light (such as incident light 30, FIG. 1), and for at least a second wavelength 51 in the longer wavelength range 43, the reflective polarizer 20 reflects greater than about 80%, or greater than about 85%, or greater than about 90%, or greater than about 95%, of the incident light.

In some embodiments, in the shorter wavelength range 42, the mirror 10 and the reflective polarizer 20 may absorb respective percentages of incident light A1% 44 and A2% 52, such that A2/A1 is greater than or equal to about 50, or about 75, or about 100, or about 150. In some embodiments, shorter wavelength range 42 may extend from about 370 nm to about 405 nm. In some embodiments, longer wavelength range 43 may extend from about 450 nm to about 490 nm.

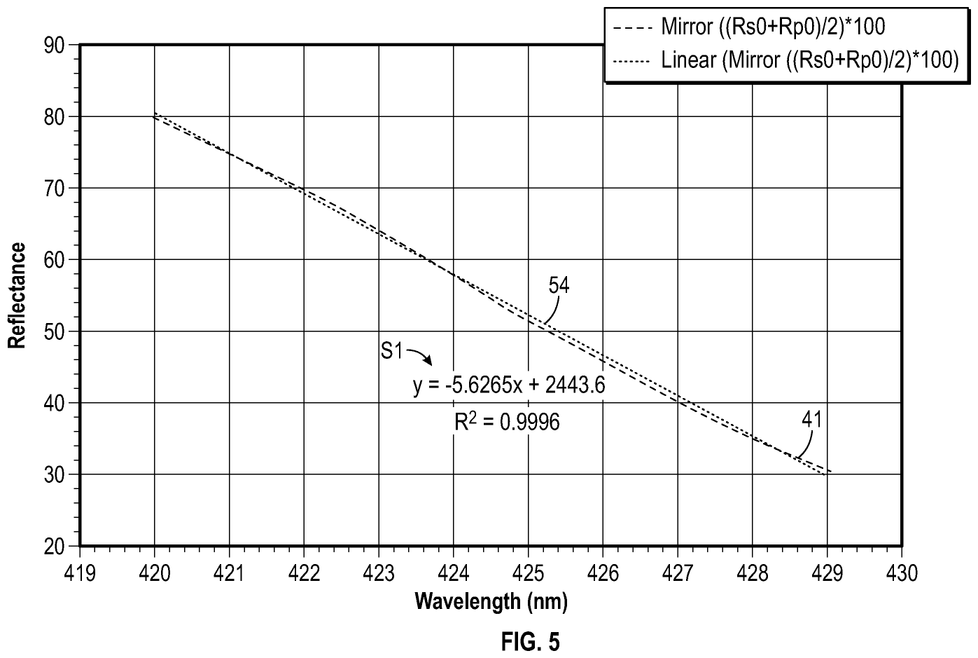

FIG. 5 shows additional detail regarding the reflective band edge 41 for some embodiments of mirror 10 (see FIGS. 1 and 2). FIG. 5 shows the plot of reflective band edge 41 extending from about 420 nm to about 429 nm. In some embodiments, a best linear fit 54 to reflection band edge 41 at least across the wavelength range along the reflection band edge 41 where the optical reflectance decreases from about 80% to about 50%, or about 40%, or about 30%, has a negative slope S1 having a magnitude of greater than about 3%/nm, or about 3.5%/nm, or about 4.5%/nm, or about 5%/nm. In some embodiments, the best linear fit has an r-squared value greater than about 0.8, or about 0.85, or about 0.9, or about 0.95.

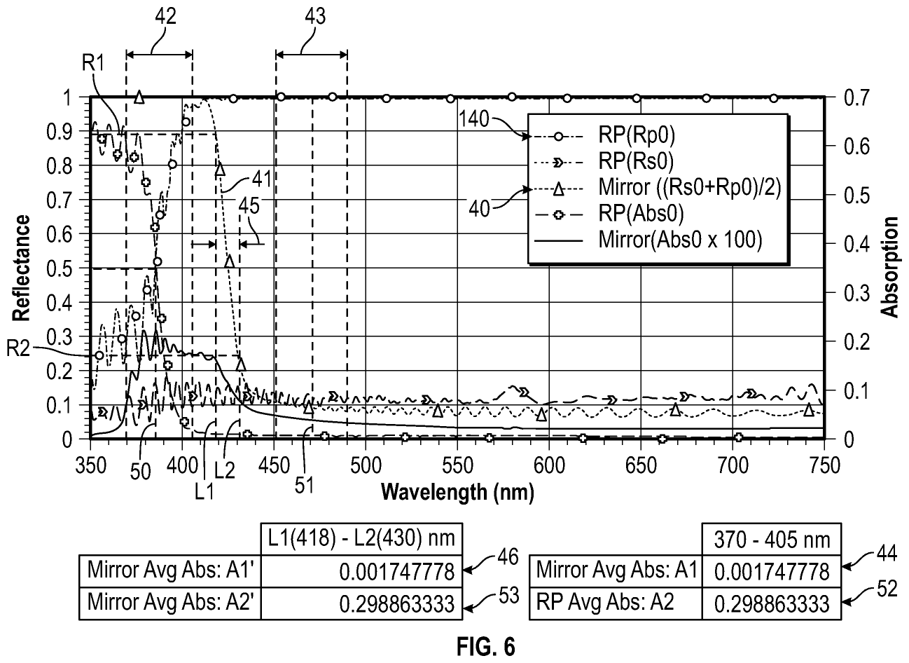

FIG. 6 again shows the optical reflectance 40 (line including triangles) of mirror 10 versus wavelength, and the optical reflectance 140 (line including circles) of reflective polarizer 20 versus wavelength. Components common to FIG. 4 shall have the same function and/or meaning as like-numbered components in FIG. 4 unless otherwise specified herein. Stated another way, FIG. 6 provides an alternate view and interpretation of the information presented in FIG. 4.

As shown in FIG. 6, mirror 10 (FIG. 1) has an optical reflectance 40 versus wavelength with a reflection band edge 41 extending at least between a higher first optical reflectance R1 and a smaller first wavelength L1, and a lower second optical reflectance R2 and a greater second wavelength L2.

Also shown in FIG. 6, reflective polarizer 20 (FIG. 1) has an optical reflectance 140 over a band edge wavelength range 45 which may extend from the smaller first wavelength L1 to the greater second wavelength L2 which has an average value of greater than about 80%, or about 85%, or about 90%, or about 95%, and which varies by less than about 20%

In some embodiments, in the band edge wavelength range 45, the mirror 10 and reflective polarizer 20 may absorb respective percentages A1′% 46 and A2′% 53 of the incident light, such that the ratio of A2′/A1′ is greater than or equal to about 2, or about 3, or about 4, or about 5, or about 6.

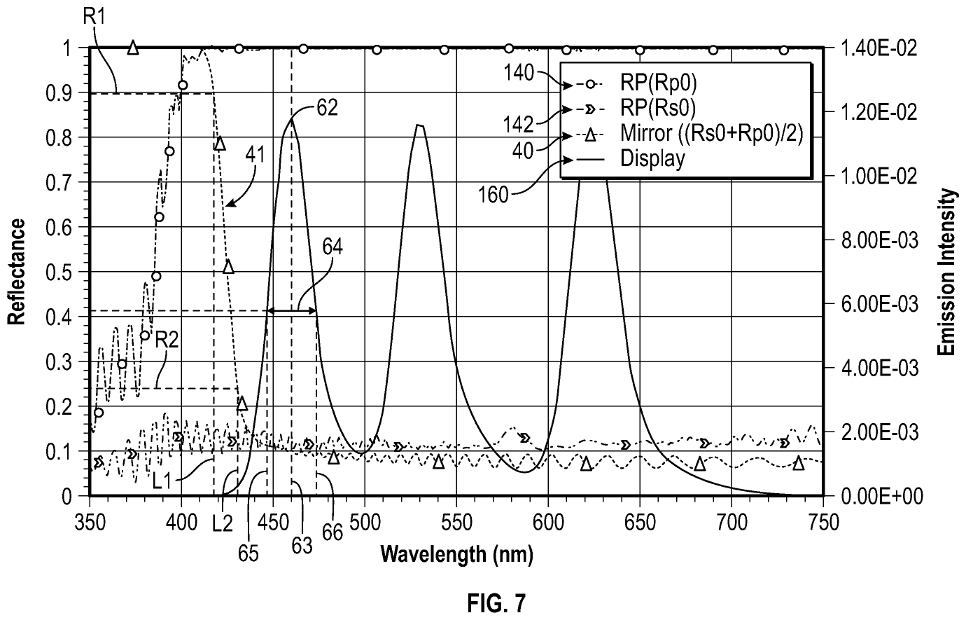

FIG. 7 plots the optical reflectance versus wavelength lines for mirror 10, reflective polarizer 20, and extended light source 60 (see 10, 20, and 60, FIGS. 1 and 2). The plot of optical reflectance versus wavelength for mirror 10 is line 40 (line with triangles), the plot of optical reflectance versus wavelength for reflective polarizer 20 for a first polarization state (e.g., p-polarized light) is line 140 (line with circles), the plot of optical reflectance versus wavelength for reflective polarizer 20 for a second orthogonal polarization state (e.g., s-polarized light) is line 142 (line with chevrons), and the plot of optical reflectance versus wavelength for extended light source 60 is line 160 (line with no identifying markers).

In some embodiments, the optical reflectance line 160 (for extended light source 60) has a blue emission peak 62 at a blue peak wavelength 63 and a corresponding full width at half maximum (FWHM) 64 extending from a smaller first blue wavelength 65 to a greater second blue wavelength 66. For wavelengths of light between the first blue wavelength 65 and the second blue wavelength 66, the reflective polarizer 20 may have an average optical reflectance of greater than about 60% for a first polarization state (line 140) and an average transmittance of greater than about 60% for an orthogonal second polarization state (line 142).

In some embodiments, the optical reflectance versus wavelength 40 for mirror 10 for each of the first and second polarization states includes a reflection band edge 41 extending at least between a higher first optical reflectance R1 at a smaller first wavelength L1 and a lower second optical reflectance R2 at a greater second wavelength L2, such that the difference R1−R2 is greater than or equal to about 40%, or about 45%, or about 50%, or about 55%, or about 60%. In some embodiments, the different L2−L1 is less than or equal to about 50 nm, or about 40 nm, or about 30 nm, or about 25 nm, or about 20 nm, or about 15 nm.

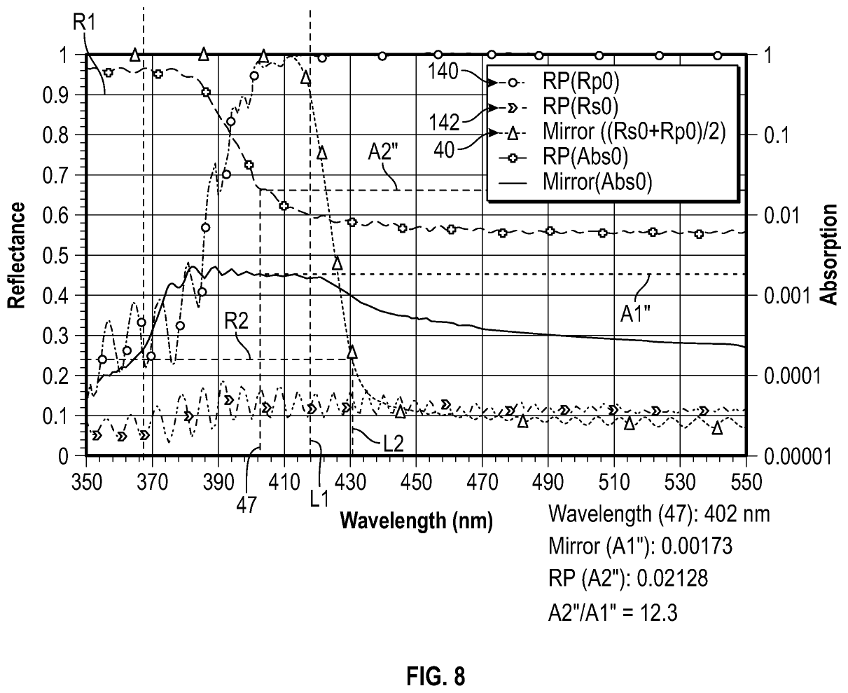

FIG. 8 plots the optical reflectance versus wavelength lines for mirror 10, and reflective polarizer 20 (see 10 and 20, FIGS. 1 and 2). Some of the components of FIG. 8 are repeated from and common with like-numbered components in FIG. 7, and serve the same function unless otherwise specified herein.

The plot of optical reflectance versus wavelength for mirror 10 is line 40 (line with triangles), the plot of optical reflectance versus wavelength for reflective polarizer 20 for a first polarization state (e.g., p-polarized light) is line 140 (line with circles), and the plot of optical reflectance versus wavelength for reflective polarizer 20 for a second orthogonal polarization state (e.g., s-polarized light) is line 142 (line with chevrons). In some embodiments, for at least one wavelength 47 smaller than, and within, about 50 nm of L1, the mirror and the reflective polarizer absorb respective A1″% and A2″% of the incident light, such that A2″/A1″ is greater than or equal to about 2, or about 5, or about 10.

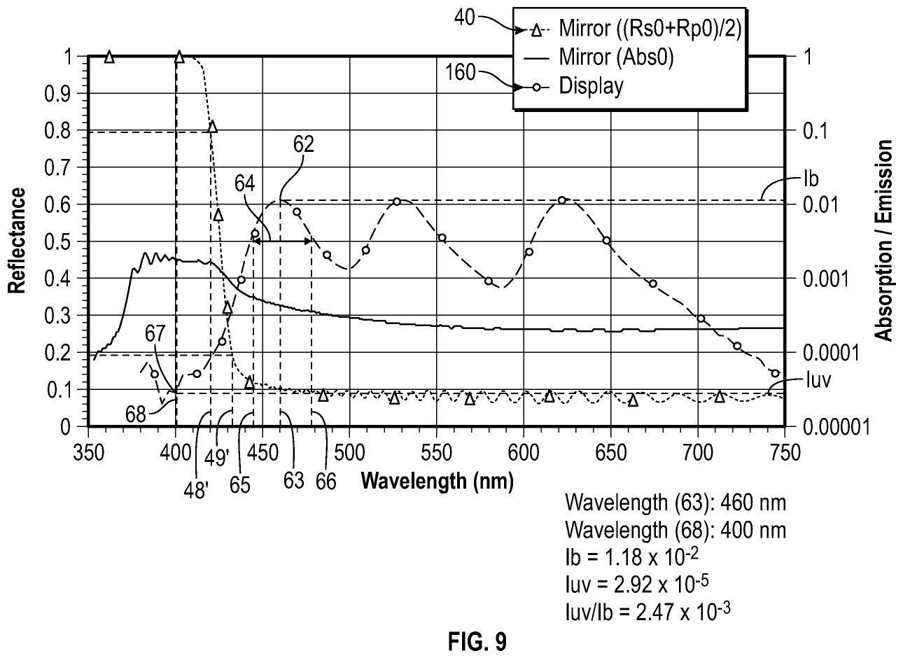

Finally, FIG. 9 provides plots for the optical reflectance versus wavelength lines for mirror 10 and extended light source 60 (see 10 and 60, FIGS. 1 and 2). The plot of optical reflectance versus wavelength for mirror 10 is line 40 (line with triangles), and the plot of optical reflectance versus wavelength for extended light source 60 is line 160 (line with circles). As shown in FIG. 9, the extended light source 60 may have a blue emission peak 62 at a blue peak wavelength 63 having an emission intensity Ib and a corresponding full width at half maximum (FWHM) 64 extending from a smaller first blue wavelength 65 to a greater second blue wavelength 66. The extended light source 60 may also have a UV emission 67 at an ultraviolet wavelength 68 less than the first blue wavelength and having an emission intensity Iuv of about 10⁻⁴, or about 2×10⁻⁴, or about 5×10⁻⁴, or about 7.5×10⁻⁴, or about 10⁻³ less than or equal to the ratio Iuv/Ib, and the ratio Iuv/Ib is less than or equal to about 10⁻¹, or about 10⁻², or about 8×10⁻³, or about 6×10⁻³, or about 4×10⁻³.

In some embodiments, the mirror 10 may, for an incident light 30 (FIG. 1) incident at an incident angle and for each of mutually orthogonal first and second polarization states, reflect at least about 60%, or at least about 70%, or at least about 80%, or at least about 90%, or at least about 95%, of the incident light at UV wavelength 68 and may transmit at least about 60%, or at least about 70%, or at least about 80%, or at least about 85% of the incident light at the blue peak wavelength.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1. An optical stack comprising:
a first optical film comprising a plurality of first polymeric layers disposed on a second optical film comprising a plurality of second polymeric layers, each of the pluralities of first and second polymeric layers numbering at least 50 in total, each of the first and second polymeric layers having an average thickness of less than about 500 nm, such that for an incident light incident at an incident angle and for a first polarization state:
an optical reflectance of the plurality of first polymeric layers versus wavelength comprises a reflection band edge separating a shorter wavelength range where the plurality of first polymeric layers reflects greater than about 70% of the incident light from a longer wavelength range where the plurality of first polymeric layers reflects less than about 30% of the incident light;
for at least a first wavelength in the shorter wavelength range, the plurality of second polymeric layers reflects less than about 70% of the incident light, and for at least a second wavelength in the longer wavelength range, the plurality of second polymeric layers reflects greater than about 80% of the incident light; and
in the shorter wavelength range, the pluralities of first and second polymeric layers absorb respective A1% and A2% of the incident light, A2/A1≥50.

2. The optical stack of claim 1, wherein the incident angle is less than about 5 degrees.

3. The optical stack of claim 1, wherein the incident angle is between about 30 and 60 degrees.

4. The optical stack of claim 1, wherein along the reflection band edge, the optical reflectance of the of the plurality of first polymeric layers decreases from about 70% at a shorter first band edge wavelength to about 30% at a longer second band edge wavelength, the first and second band edge wavelength disposed between about 410 nm and about 440 nm.

5. The optical stack of claim 1, wherein a best linear fit to the reflection band edge at least across a wavelength range along the reflection band edge where the optical reflectance decreases from about 80% to about 50% has a negative slope having a magnitude of greater than about 3%/nm.

6. The optical stack of claim 1, wherein the best linear fit has an r-squared value greater than about 0.8.

7. The optical stack of claim 1, wherein the first optical film defines an x-axis along a first polarization state, a y-axis along an orthogonal second polarization state perpendicular to the x-axis, and a z-axis along a thickness direction of the first optical film orthogonal to the x- and y-axes, the plurality of first polymeric layers comprising a plurality of alternating polymeric A and B layers, each of the A and B layers having an index nx along the x-axis, an index ny along the y-axis, and an index nz along the z-axis, wherein:
for the A layers, nx>ny>nz, nx is greater than ny by at least about 0.01, and ny is greater than nz by at least about 0.025;
for the B layers, a magnitude of a maximum difference between nx, ny and nz is less than about 0.01; and
a magnitude of a difference between the nz of the A and B layers is less than about 0.01.

8. The optical stack of claim 1, wherein the plurality of first polymeric layers of the first optical film comprises a plurality of alternating polymeric A and B layers, each A layer comprising polyethylene terephthalate (PET), each B layer comprising polymethylmethacrylate (PMMA).

9. The optical stack of claim 1, wherein the plurality of first polymeric layers numbers at least 75 in total.

10. The optical stack of claim 1, wherein the second optical film defines an x-axis along a first polarization state, a y-axis along an orthogonal second polarization state perpendicular to the x-axis, and a z-axis along a thickness direction of the second optical film orthogonal to the x- and y-axes, the plurality of second polymeric layers comprising a plurality of alternating polymeric C and D layers, each of the C and D layers having an index nx along the x-axis, an index ny along the y-axis, and an index nz along the z-axis, wherein:
for the C layers, nx>ny>nz, nx is greater than ny by at least about 0.05, and ny is greater than nz by more than about 0.01 and less than about 0.03;
for the D layers, a magnitude of a maximum difference between nx, ny and nz is less than about 0.01; and
a magnitude of a difference between the nx of the A and B layers is greater than about 0.05.

11. The optical stack of claim 1, wherein the plurality of second polymeric layers of the second optical film comprises a plurality of alternating polymeric C and D layers, each C layer comprising polyethylene naphthalate (PEN), each D layer comprising polycarbonate (PC).

12. The optical stack of claim 1, wherein the plurality of second polymeric layers numbers at least 100 in total.

13. An optical stack comprising:
a first optical film comprising a plurality of first polymeric layers disposed on a second optical film comprising a plurality of second polymeric layers, each of the pluralities of first and second polymeric layers numbering at least 50 in total, each of the first and second polymeric layers having an average thickness of less than about 500 nm, such that for an incident light incident at an incident angle and for a first polarization state:
an optical reflectance of the plurality of first polymeric layers versus wavelength comprises a reflection band edge extending at least between a higher first optical reflectance at a smaller first wavelength and a lower second optical reflectance at a greater second wavelength;
an optical reflectance of the plurality of second polymeric layers over a band edge wavelength range extending from the smaller first wavelength to the greater second wavelength has an average value of greater than about 80% and varies by less than about 20%; and
in the band edge wavelength range, the pluralities of first and second polymeric layers absorb respective A1′% and A2′% of the incident light, A2′/A1′≥2.

14. The optical stack of claim 13, wherein the incident angle is less than about 5 degrees.

15. The optical stack of claim 13, wherein the incident angle is between about 30 and 60 degrees.

16. A display system (300) comprising:
an extended light source configured to emit light from an emission surface thereof, the emitted light having a blue emission peak at a blue peak wavelength and a corresponding full width at half maximum extending from a smaller first blue wavelength to a greater second blue wavelength;
a mirror; and
a reflective polarizer configured to receive the light emitted by the extended light source through the mirror, each of the mirror and the reflective polarizer comprising a plurality of polymeric layers numbering at least 50 in total, such that for an incident light incident at an incident angle:
for the wavelengths between the first and the second blue wavelengths, the reflective polarizer has an average reflectance of greater than about 60% for a first polarization state and an average transmittance of greater than about 60% for an orthogonal second polarization state; and
an optical reflectance of the mirror versus wavelength for each of the first and second polarization states comprises a reflection band edge extending at least between a higher first optical reflectance R1 at a smaller first wavelength L1 and a lower second optical reflectance R2 at a greater second wavelength L2, R1−R2≥40%, L2−L1≤50 nm, wherein for at least one wavelength smaller than, and within, about 50 nm of L1, the mirror and the reflective polarizer absorb respective A1″% and A2″% of the incident light, A2″/A1″≥2.

17. The display system of claim 16, wherein the incident angle is less than about 5 degrees.

18. The display system of claim 16, wherein the incident angle is between about 30 and 60 degrees.

19. The display system of claim 16, wherein the emission surface, the mirror and the reflective polarizer are substantially parallel, and co-extensive in length and width, with each other.

20. The display system of claim 16, wherein the mirror and the reflective polarizer are substantially parallel, and co-extensive in length and width, with each other, and the emission surface makes an angle of between about 20 degrees and 70 degrees with the mirror.

21. The display system of claim 18, wherein the extended light source comprises an image forming display panel comprising a plurality of pixel, and wherein the emitted light comprises an emitted image.

22. The display system of claim 18 being a virtual reality display system for forming a virtual image of an image emitted by the image forming display panel for viewing by a viewer.

23. The display system of claim 22, further comprising first and second at least partial mirrors, such that the image emitted by the image forming display panel propagates toward the viewer after it is first received and reflected by the reflective polarizer toward the first at least partial mirror, and then reflected by the first at least partial mirror toward the second at least partial mirror.

24. The display system of claim 23, wherein the second at least partial mirror comprises a windshield of a vehicle.

25. The display system of claim 23, wherein the first at least partial mirror is a reflective polarizer.

26. The display system of claim 23, wherein the first at least partial mirror is the optical stack of claim 13.

27. The display system of claim 22, further comprising first and second at least partial mirrors, such that the image emitted by the image forming display panel propagates toward the viewer after it is first received and reflected by the first at least partial mirror, and then reflected by the reflective polarizer toward the second at least partial mirror.

28. A display system comprising:
an extended light source configured to emit light having:
a blue emission peak at a blue peak wavelength having an emission intensity Ib and a corresponding full width at half maximum extending from a smaller first blue wavelength to a greater second blue wavelength; and
an ultraviolet emission at an ultraviolet wavelength less than the first blue wavelength and having an emission intensity Iuv, 10⁻⁴≤Iuv/Ib≤10⁻¹; and
a mirror configured to receive the light emitted by the extended light source and comprising a plurality of first polymeric layers numbering at least 50 in total, each of the first polymeric layers having an average thickness of less than about 500 nm, such that for an incident light incident at an incident angle and for each of mutually orthogonal first and second polarization states, the plurality of first polymeric layers reflects at least 60% of the incident light at the ultraviolet wavelength and transmits at least 60% of the incident light at the blue peak wavelength.

29. The display system of claim 28, wherein the incident angle is less than about 5 degrees.

30. The display system of claim 28, wherein the incident angle is between about 30 and 60 degrees.

31. A display system comprising:
an extended light source configured to emit light having a blue emission peak at a blue peak wavelength having an emission intensity Ib and a corresponding full width at half maximum extending from a smaller first blue wavelength to a greater second blue wavelength; and
a mirror configured to receive the light emitted by the extended light source and comprising a plurality of first polymeric layers numbering at least 50 in total, each of the first polymeric layers having an average thickness of less than about 500 nm, such that for an incident light incident at an incident angle and for each of mutually orthogonal first and second polarization states, an optical reflectance of the plurality of first polymeric layers versus wavelength comprises a reflection band edge separating a shorter wavelength range where the plurality of first polymeric layers reflects greater than about 70% of the incident light from a longer wavelength range where the plurality of first polymeric layers reflects less than about 30% of the incident light,
wherein along the reflection band edge, the optical reflectance of the of the plurality of first polymeric layers decreases from about 80% at a shorter first band edge wavelength to about 30% at a longer second band edge wavelength, the first and second band edge wavelengths less than, and disposed within less than about 50 nm of, the first blue wavelength, and
wherein a best linear fit to the reflection band edge at least across the wavelength range from the first band edge wavelength to the second band edge wavelength has a negative slope having a magnitude of greater than about 3%/nm.

32. The display system of claim 31, wherein the incident angle is less than about 5 degrees.

33. The display system of claim 31, wherein the incident angle is between about 30 and 60 degrees.
